(19) United States
(12) Patent Application Publication
(10) Pub. No.: US 2026/0116161 A1
(43) Pub. Date: Apr. 30, 2026

(54) Pickup Truck Tailgate Cover

(71) Applicant: ZHEJIANG SURPASS AUTO PARTS CO.,LTD., Wenzhou City (CN)

(72) Inventors: Yi Lin, Wenzhou City (CN); Lei Lin, Wenzhou City (CN)

(21) Appl. No.: 19/013,420

(22) Filed: Jan. 8, 2025

(30) Foreign Application Priority Data
Oct. 30, 2024 (CN) 202411533150.9

(51) Int. Cl. B60J 7/14

(52) U.S. Cl. CPC B60J 7/141

(57) ABSTRACT

The present invention discloses a pickup truck tailgate rear cover, relates to the technical field of automotive parts. Each panel assembly comprises a panel and a plurality of side frames surrounding it. The side of one panel assembly is connected to the side of an adjacent panel assembly through a adapter. The side of the frame is provided with a first supporting section, with a first mating section formed on the inside of the first supporting section. The pickup truck tailgate rear cover provided in this embodiment achieves parallel connections between panel assemblies through adapters, expanding the overall coverage area. The segmented design reduces the possibility of bending. The end panel is connected to a guide rail through locking parts. The guide rails are further connected to form an integrated unit through adapters, which enhancing overall rigidity and extends the service life of the pickup truck tailgate rear cover.

### CROSS-REFERENCE TO RELATED APPLICATIONS

This application claims priority benefits to Chinese Patent Application No. 2024115331509, filed on Oct. 30, 2024, the contents of which are incorporated herein by reference.

### TECHNICAL FIELD

This invention is relevant to technical field of automotive parts, especially a pickup truck tailgate cover

### BACKGROUND TECHNOLOGY

Pickup trucks, as a common type of vehicle, offer car-like comfort without losing power. Due to its strong cargo carrying and adaptability to poor road conditions and its strong overall performance, pickup trucks have become one of the most common off-road vehicles nowadays. In order to adapt to more diverse environments, most existing pickup trucks need to be fitted with a car cover, which is made of a plurality of panels spliced together. The current connection between the frames on the market is mostly non-connection or use plastic parts to connect, there is no effective fixing around the panel, with poor structural strength and prone to sliding, detachment and bending and other risks.

### About the Invention

The embodiments of the present invention provide a pickup truck tailgate rear cover that addresses, at a minimum, the technical problem of the panels prone to sliding, detachment and bending.

In order to solve the above problems of the existing technology, the technical solution adopted in the invention is as follows:

Each panel assembly comprises a panel and a plurality of frames surrounding it. The side of one panel assembly is connected to the side of an adjacent panel assembly by an adapter. The side of the frame is provided with a first supporting section, with a first mating section formed on the inner side of the first supporting section. The adapter comprises an elastic strip, which comprises an elastic strip body with an upper and lower surface. The lower surface of the elastic strip body is provided with a first pending connection section and a second pending connection section on its left and right sides, respectively. The first pending connection section mates with the first mating section, Once mated, the elastic strip body forms an inclined plane. The upper surface of the elastic strip body at the end of the second pending connection section is higher than that at the first pending connection section.

The beneficial effects of this invention are as follows: The pickup truck tailgate cover provided in the embodiments of this invention significantly enhances the overall structural strength of the cover by reinforcing each panel assembly with a plurality of frames arranged around the edges of the panels. The parallel connection of the panel assemblies is achieved through the adapter to expand the overall coverage area, the segmented design reduces the possibility of bending. Further, the end panel is connected to guide rails through the locking parts, the guide rails are further connected to form an integrated unit through connectors, which enhancing overall rigidity and extends the service life of the pickup truck tailgate cover.

Further, a plurality of guide rails are arranged at the end surfaces of the panel assemblies, the guide rails are connected to the panel assembly by locking parts, one of the guide rail is connected to an adjacent guide rail through a connector. The second pending connection section is connected with the first mating section in the frame of another panel assembly or the second mating section on the rotating shaft.

Further, the adapter further comprises a rotating shaft, both side of the second supporting sections are provided with a second supporting section. A second mating section is formed on the inner side of the second supporting section, the first pending connection section or the second pending connection section is connected with the second mating section.

In one embodiment, a pickup truck tailgate cover, detachably mounted on the rear cargo hopper, comprising a plurality of panel assemblies spliced together. Each panel assembly comprises a panel and a plurality of frames surrounding it. The side of one panel assembly is connected to the side of an adjacent panel assembly by a adapter. The side of the frame is provided with a first supporting section, with a first mating section formed on the inner side of the first supporting section. The adapter comprises an elastic strip, which comprises an elastic strip body with an upper surface and a lower surface. The lower surface of the elastic strip body is provided with a first pending connection section and a second pending connection section on its left and right sides, respectively. Wherein, the first pending connection section mates with the first mating section to form an inclined surface for the elastic strip body after mating. The upper surface of the elastic strip body at the end of the second pending connection section is higher than the upper surface at the end of the first pending connection section. The elastic strip further comprises a support mating section located at the bottom of the elastic strip body, the second pending connection section mates with the frame of another panel assembly or the first mating section on the fixing panel, or the second mating section on the rotating shaft.

Further, the elastic strip further comprises a support mating section, which is provided at the bottom of the elastic strip body or between the bottom of the elastic strip body and its lower surface. The overall shape can be a “T” shape, an inverted “T” shape, a “ [symbol] ” shape, a “ [symbol] ” shape, or a “+” shape. It can also be configured as a left or right half of the aforementioned shapes, such as the left half of a “T” shape resembling a “7” shape, or the right half resembling a reversed “7” shape.

Further, the cross-section of the horizontal straight portion of the inverted “T”-shaped support mating section is in trapezoidal shape, with the lower side being longer than the upper side.

Further, the support mating section is greater than or equal to the distance between the first supporting section and the second supporting section.

Further, the support mating section can be in contact with the first supporting section and/or the second supporting section.

Further, the support mating section can may not be in contact with the first supporting section and/or the second supporting section.

Further, a first sliding groove is provided along the length of the frame; a elongated hole is provided on the surface perpendicular to the guide rail and the extension plane of the guide rail, the locking part comprises a screw, the screw passes through the elongated hole to connected with the guide rail.

Further, the locking part further comprises a screw base inserted into the first sliding groove, the screw passes through the elongated hole and is threadably connected to a nut, locking the guide rail and the frame together.

Further, a groove is provided along the surface of the screw base and comprises an opening. A rotating rod is rotatably connected within the groove, the screw is vertically connected to the center of the rotating rod. The screw can swing along the opening.

Further, the nut abuts the guide rail body and forms a mating surface on the guide rail body, while a contact surface is formed at the nut.

Further, the guide rail is provided with a supporting block at specific positions, the supporting block is provided with a load-bearing section to enhance the local rigidity of the guide rail.

Further, the guide rail comprises a guide rail body. The guide rail body is provided with a second sliding groove along the vertical direction and a support groove in the horizontal direction. A support block is slidably connected within the guide rail, the support block comprises a guiding section and a load-bearing section, which are vertically arranged. The guiding section is slidably connected to the second sliding groove, the load-bearing section is slidably connected to the support groove.

Further, the connector comprises a connector female end and a connector male end. One part of the connector female end is inserted into the second sliding groove of one guide rail, while another part of the connector female end is inserted into the second sliding groove of an adjacent guide rail. An extension section is provided on the inner side of the second sliding groove. The connector male end is provided opposite the connector female end, with at least two screw holes are provided correspondingly on their surfaces. The connector male and connector female ends are fixed together with screws and abut the extension section, connecting the two adjacent guide rails in series.

### DESCRIPTION OF FIGURE

FIG. 1 is a first perspective schematic view of the pickup truck tailgate rear cover of the embodiment in the present invention

FIG. 2 is an enlarged view of FIG. 1A;

FIG. 3 is an axonometric view of a locking part of the embodiment in the present invention;

FIG. 4 is an assembly diagram of the guide rail with the support block and the locking part of the embodiment in the present invention;

FIG. 5 is a second perspective schematic view of the pickup truck tailgate rear cover of the embodiment in the present invention;

FIG. 6 is an exploded view of a connector of the embodiment in the present invention;

FIG. 7 is an assembly diagram of the guide rail and connector of the embodiment in the present invention;

FIG. 8 is an assembly diagram of the adapter and the two frames of the embodiment in the present invention;

FIG. 9 is an assembly diagram of the adapter and one of the frames of the embodiment in the present invention;

FIG. 10 is an assembly diagram of the adapter with an alternative embodiment of the frame;

FIG. 11 is an assembly process diagram of the elastic strip and the frame of the embodiment in the present invention;

FIG. 12 is an assembly diagram of the elastic strip in another embodiment with the frame (unfolded state);

FIG. 13 is a schematic diagram of the position of the fixing panel of the embodiment in the present invention.

### FIGURES

Panel;
2. Frame, 21: First Frame, 211: First Sliding Groove, 22: Second Frame, 221: First Supporting Section, 222: First mating section, 23: Third Frame
3. Guide Rail, 31: Guide Rail Body, 32: Second Sliding Groove, 33: Supporting Groove, 34: mating surface, 35: Extension Section, 36: Elongated Hole
4. Supporting Block, 41: Guiding Section, 42: Load-bearing Section
5. Locking part, 51: Screw Base, 52: Groove, 53: Opening, 54: Rotating Rod, 55: Screw Rod, 56: Nut
6. Contact Surface
7. Connector, 71: Connector Female End, 711: First Screwing Hole, 72: Connector Male End, 721: Second Screwing Hole, 73: Screw
8. Adapter, 81: Rotating Shaft, 811: Second Supporting Section, 812: Second mating section, 82: Elastic Strip, 821: Elastic Strip Body, 8211: First Surface, 8212: Second Surface, 8201: Third Surface, 8202: Fourth Surface, 8203: Fifth Surface, 822: First Pending mating section, 823: Second Pending mating section, 824: Supporting mating section, Q7: Fixing panel

### THE CONCRETE METHOD TO CARRY OUT

The following instruction further explains the invention's concrete implementation method.

In the description in this invention, it is to be understood that the orientation or positional relationships indicated by the terms “top”, “bottom”, “inside”, “outside”, “top”, “bottom”, “top”, “bottom”, “inside”, “bottom”, “inside”, “outside”, etc. are based on the orientation or positional relationships shown in the accompanying drawings, which serve only to facilitate the description in this invention and simplify the description, and are not to be construed as limiting the present invention in any way as they indicate or imply that the device or element referred to must be constructed and operated with a specific orientation or be constructed and operated in a specific orientation.

The terms “first”, “second”, “third”, etc. are only used to differentiate the description and should not be construed as indicating or implying relative importance. Thus, a feature defined with the terms “first”, “second” may expressly or implicitly include one or more such features. For the purposes of the description in this invention, unless otherwise indicated, “more than one” means two or more.

In the description of the invention, it should also be noted that, unless otherwise expressly specified and limited, the terms “arranged,” “installed,” “connected,” and “combined” should be understood in a broad sense. for example, it may be a fixing connecting, it can also be a detachable connecting or an integral connecting. it can be a mechanical connecting or an electrical connecting. it can be a direct connecting or an indirect connecting through an intermediate media. And it can be internal connecting within two assemblies. For those of ordinary skill in this field, specific meanings of the above terms in the present invention can be understood in specific situations.

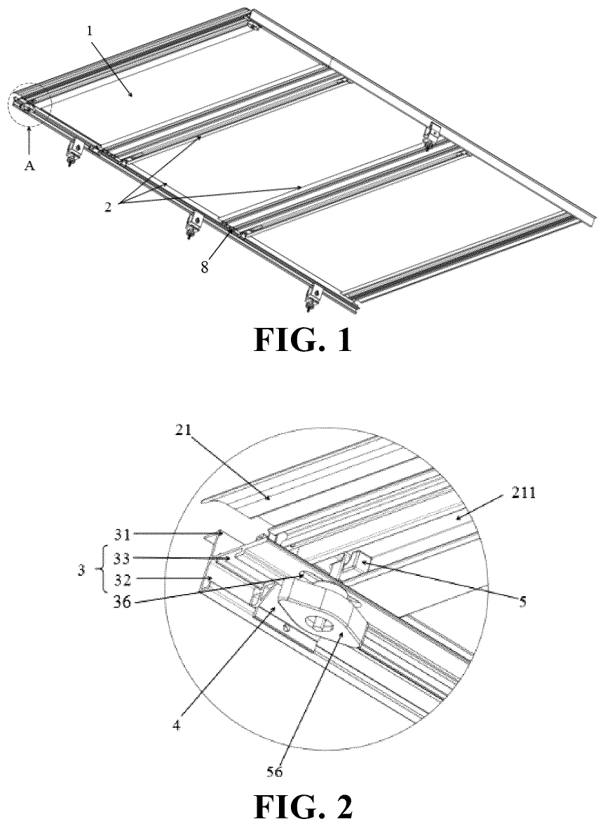

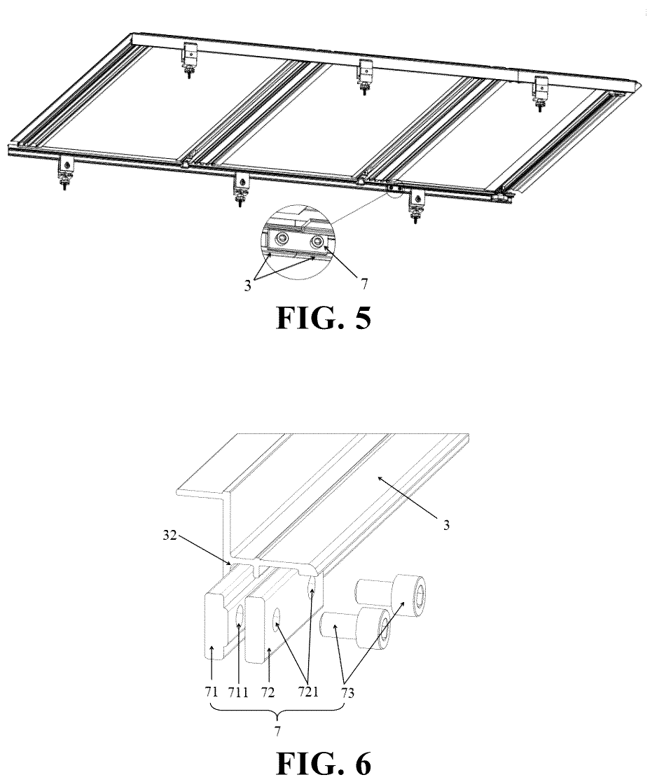

This embodiment of the invention provides a pickup truck tailgate cover, which is detachably mounted on the rear cargo hopper, comprising a plurality of panel assemblies spliced together. Refer to FIGS. 1 and 5, each panel assembly comprises a panel 1 a plurality of frames 2 surrounding it. The side of one panel assembly is connected to the side of an adjacent panel assembly by an adapter 8.

The side of the frame 2 is provided with a first supporting section 221, with a first mating section 222 formed on the inner side of the first supporting section 221. The adapter 8 comprises an elastic strip 82, which comprises an elastic strip body 821 with an upper surface and a lower surface. The lower surface of the elastic strip body 821 is provided with a first pending connection section 822 and a second pending connection section 823 on its left and right sides, respectively. The first pending connection section 822 mates with the first mating section 222. Once mated, the elastic strip body 821 forms an inclined plane. The upper surface at the end of the second pending connection section 823 is higher than that at the end of the first pending connection section 822. A plurality of guide rails 3 are arranged at the end surface of the panel assembly, the guide rails 3 are connected to the panel assembly through the locking parts 5, wherein one of the guide rails 3 is connected to an adjacent guide rail 3 through a connector 7, wherein, the second pending connection section 823 mates with the frame of another panel, or the first mating section 222 in the fixing panel or the second mating section 812 on the rotating shaft 81.

The pickup truck tailgate cover provided in the embodiments of this invention significantly enhances the overall structural strength of the cover by reinforcing each panel assembly with a plurality of frames 2 arranged around the edges of the panels 1. The parallel connection of the panel assemblies is achieved through the adapter 8 to expand the overall coverage area, the segmented design reduces the possibility of bending. Further, the end panel is connected to guide rails through the locking parts 5, the guide rails 2 are further connected to form an integrated unit through connector 7, which enhancing overall rigidity and extends the service life of the pickup truck tailgate cover.

It should be noted that after the pickup truck tailgate rear cover is fastened to the pickup truck tailgate, in the unfolded state, the upper surface of the elastic body 821 faces upwards, or the lower surface of the elastic strip 821 faces towards the bottom surface of the pickup truck tailgate.

In some embodiments, in addition to the connection between the frames of adjacent panels (1), the frames of the panels (1) are also connected to the front panel (profile).

Hereinafter, for specific embodiments of the above mentioned adapter 8, please refer to FIGS. 8 and 9, the adapter 8 further comprises a rotating shaft 81, the left and right sides of the rotating shaft 81 is provided with a second supporting section 811, with a second mating section 812 formed on the inner side of the second supporting section 811, the second mating section 812 is connected with the first pending connection section 822 or a second pending connection section 823.

It is should be noted that the lower surface of the elastic strip body 821 includes a downward-extending surface located between the frames or between a frame and the rotating shaft 81. The left and right sides of the extension surface respectively abut against the frame or the rotating shaft 81. The gap between the frame located at the left abutment surface of the extension surface and the bottom surface of the elastic strip body 821, as well as the frame or rotating shaft 81 at the right abutment surface of the extension surface and the bottom surface of the elastic strip body 821, is less than or equal to the width of the extension surface. Moreover, there is a compression between the frame and the rotating shaft 81 on the extension surface, especially the downward compression, which provides a waterproof effect when downward, as well as a better fit and a flatter surface of the cover.

In one embodiment, a pickup truck tailgate cover, detachably mounted on the rear cargo hopper, comprising a plurality of panel assemblies spliced together. Each panel assembly comprises a panel 1 and a plurality of frames 2 surrounding it. The side of one panel assembly is connected to the side of an adjacent panel assembly by a adapter 8. The side of the frame 2 is provided with a first supporting section 221, with a first mating section 222 formed on the inner side of the first supporting section 221. The adapter 8 comprises an elastic strip 82, which comprises an elastic strip body 821 with an upper surface and a lower surface. The lower surface of the elastic strip body 821 is provided with a first pending connection section 822 and a second pending connection section 823 on its left and right sides, respectively. Wherein, the first pending connection section 822 mates with the first mating section 222 to form an inclined surface for the elastic strip body 821 after mating. The upper surface at the end of the second pending connection section 823 is higher than the upper surface at the end of the first pending connection section 822. The elastic strip 82 further comprises a support mating section 824 located at the bottom of the elastic strip body 821, the second pending connection section 823 mates with the frame of another panel assembly or the first mating section 222 on the fixing panel, or the second mating section 812 on the rotating shaft 81.

Further referring to FIG. 9, in order to improve the overall support ability, the elastic strip 82 further comprises a support mating section 824, which is provided at the bottom of the elastic strip body 821 or between the bottom of the elastic strip body 821 and the elastic strip body 821 lower surface. The overall shape can be a “T” shape, an inverted “T” shape, a “ [symbol] ” shape, a “ [symbol] ” shape, or a “+” shape. It can also be configured as a left or right half of the aforementioned shapes, such as the left half of a “T” shape resembling a “7” shape, or the right half resembling a reversed “7” shape.

For example, if the supporting mating section 824 as a whole appears as an inverted T-shape or a portion of an inverted T-shape, the cross-section of the transverse portion of the inverted T-shape supporting mating section 824 is in trapezoidal shape, with the lower side being longer than the upper side. the supporting mating section 824 is greater than or equal to the distance between the first supporting section 221 and the second supporting section 811, the supporting mating section 824 can be in contact with the first supporting section 221 and the second supporting section 811, and/or can not be in contact. The portion of the inverted T-shaped part can be a “7” shaped structure on the left side of the inverted T-shaped part, or can be a “7” shaped structure on the right side of the inverted T-shaped part.

With reference to FIGS. 2-FIG. 4, in order to lock the guide rail 3 with the side frame, a first sliding groove 211 is provided along the length of the frame 2; a elongated hole 36 is provided on the surface perpendicular to the guide rail 3 and the extension plane of the guide rail 3; the locking part 5 comprises a screw 55, the screw 55 passes through the elongated hole 36 to connected with the guide rail 3.

As show in FIG. 9, the left side of the supporting mating section 824 abuts the frame 2 of the panel, the right side of the supporting mating section 824 abuts the rotating shaft 81 or the frame 2 of another panel assembly. The left side abutting part of the supporting mating section 824 is divided into its left upper surface and left lower surface, where the surface facing the clastic strip body 821 is defined as the upper surface. The right side abutting part of the supporting mating section 824 is divided into its right upper surface and right lower surface, where the surface facing the clastic strip body 821 is defined as the upper surface.

It should be clarify that the distance (Distance identified by L as shown in FIG. 9) between the left abutting surface and the right abutting surface of the supporting mating section 824 is greater than or equal to the distance between section A and section B. Wherein as show in FIG. 9, section A refers to the section between the lower surface of the clastic strip body 821 at the frame 2 or rotating shaft 81 and the upper surface of the left abutting part of the supporting mating section 824 (including the upper surface contact point). Section B refers to the section between the lower surface of the elastic strip body 821 at the frame 2 or rotating shaft 81 and the upper surface of the right abutting part of the supporting mating section 824 (including the upper surface contact point).

It is noted here that the mounting location of the screw 55 can be either the bottom surface of the front panel or the bottom surface of the panel body.

The locking part 5 further comprises a screw base 51 inserted into the first sliding groove 211. The screw 55 passes through the elongated hole 36 and is threadably connected to a nut 56, locking the guide rail 3 and the frame together.

It should be noted that the first sliding groove 211 can be a profile in the shape of a square or rectangular “ [symbol] ” with an opening to serve as the sliding groove, or it may feature an oblong hole.

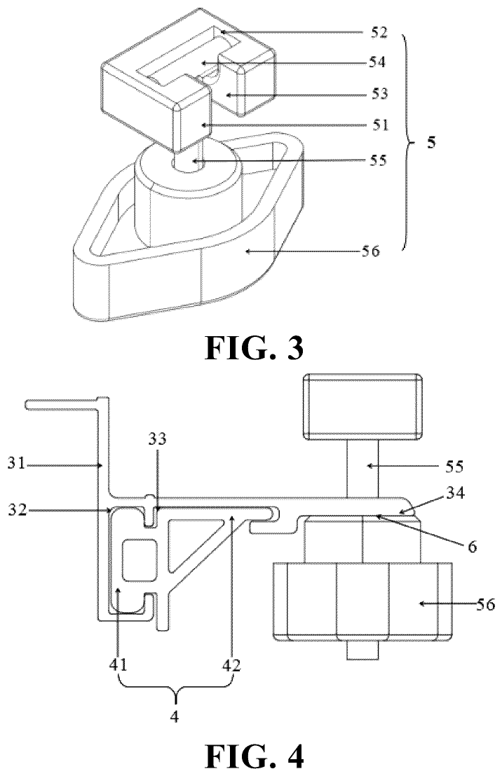

To allow the screw 55 to be flexibly connected, refer to FIGS. 3 and 4. a groove 52 is provided along the surface of the screw base 51 and comprises an opening 53. A rotating rod 54 is rotatably connected within the groove 52, the screw 55 is vertically connected to the center of the rotating rod 54. The screw 55 can swing along the opening 53, a nut 56 abuts the guide rail body 31 and forms a mating surface 34 on the guide rail body 31, while a contact surface is formed at the nut 56.

Hereinafter, with specific embodiments of the guide rails 3 mentioned above, see FIGS. 2 and 4, the guide rail 3 is provided with a supporting block 4 at specific positions, the supporting block 4 is provided with a load-bearing section 42 to enhance the local rigidity of the guide rail 3. A guide rail 3 comprises a guide rail body 31, the guide rail body 31 is provided with a second sliding groove 32 along the vertical direction, a supporting groove 33 is provided in the horizontal direction of the guide rail body 31. A supporting block 4 is slidably connected within the guide rail 3, the supporting block 4 comprises a guide section 41 and a load-bearing section 42) which are vertically arranged. The guide section 41 is slidably connected to the second sliding groove 32, while the load-bearing section 42 is slidably connected to the support groove 33.

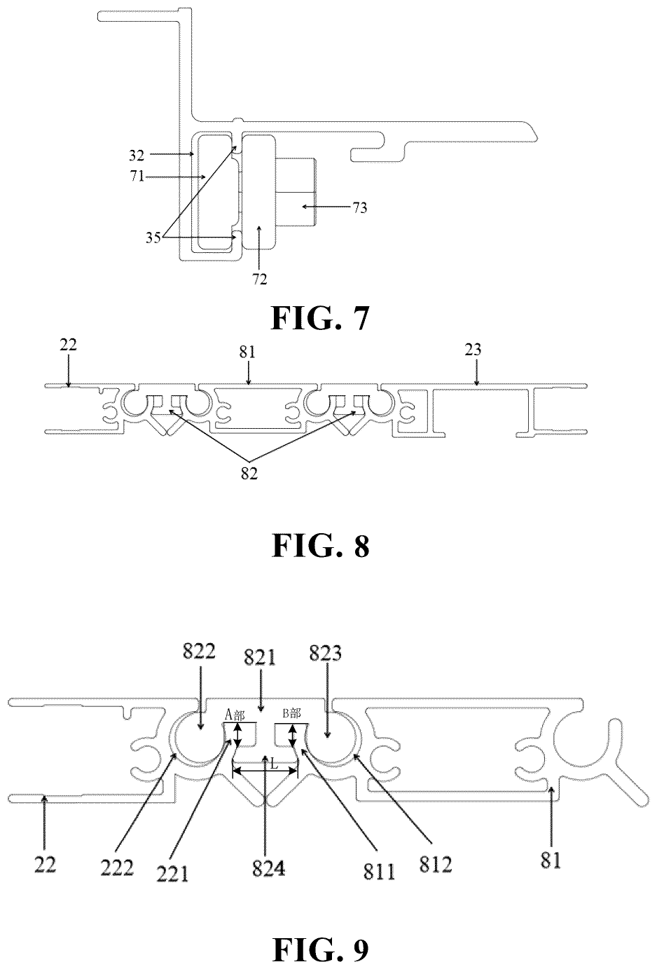

Hereinafter, with specific embodiments of the connector 7 mentioned above, see FIGS. 6 and 7,

The connector 7 comprises a connector female end 71 and a connector male end 72. One part of the connector female end 71 is inserted into the second sliding groove 32 of one of the guide rails 3, while another part of the connector female end 71 is inserted into the second sliding groove 32 of an adjacent guide rail 3. An extension section 35 is provided on the inner side of the second sliding groove 32. The connector male end 72 is provided opposite the connector female end 71, with at least two screw holes are provided corresponding to the surfaces of both the connector male end 72 and the connector female end 71. A first screw hole 711 is provided on the surface of the connector female end 71 and a second screw hole 721 is provided on the surface of the connector male end 72, the connector male end 72 and the connector female end 71 are fixed together by screws 73 against the extension section 35, and two adjacent guide rails 3 are connected together in series.

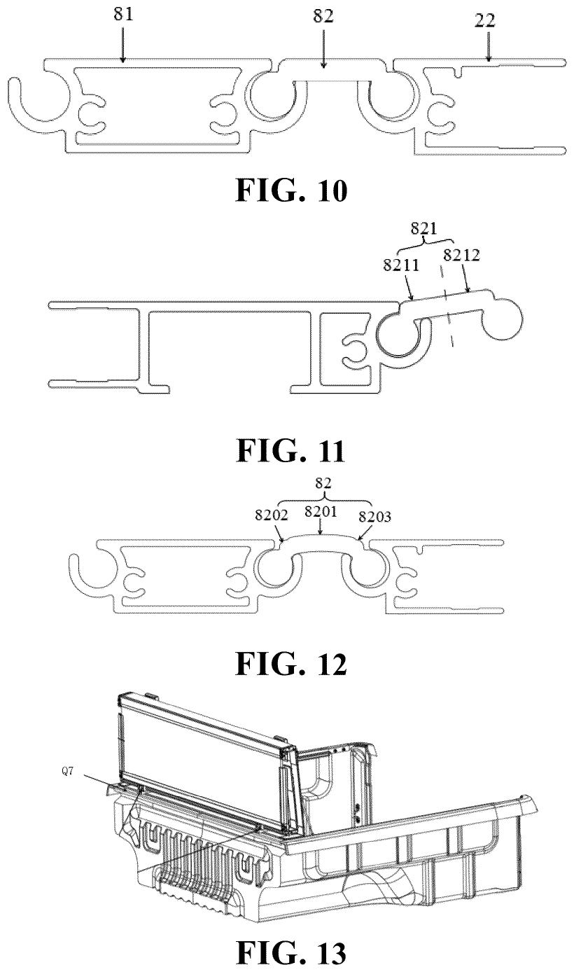

Refer to FIG. 10, a schematic diagram of the adapter 8 and the frame in another embodiment.

Referring to FIG. 11, an assembly process diagram of the elastic strip 82 with the frame of the embodiment in the present invention is shown, in order to facilitate the assembly, the pending mating section on one side of the elastic strip 82 is first worn into the mating section of the frame in the assembly process, the first surface 8211 close to the frame is lower than the second surface 8212 away from the frame.

FIG. 12 is the assembly diagram of another embodiment of the elastic strip 82 with the frame, in another embodiment of the elastic strip 82, there is a third surface 8201 located in the central portion, a fourth surface 8202 and a fifth surface 8203 located on the left and right sides of the third surface 8201, the height of the fourth surface 8202 and the fifth surface 8203 is lower than the height of the third surface 8201, creating a configuration that is high in the center and low on both sides

A pickup truck tailgate cover in another embodiment, which s detachably mounted on the rear cargo hopper, comprising a plurality of panel assemblies spliced together, each panel assembly comprises a panel 1 and a plurality of frames 2 surrounding it.

The side of one panel assembly is connected to the side of an adjacent panel assembly by a adapter 8.

The side of the frame 2 is provided with a first supporting section 221 and forms a first mating section 222 on the inner side of the first supporting section 221.

The adapter 8 comprises an elastic strip 82, which comprises an elastic strip body 821 with an upper surface and a lower surface. The lower surface of the elastic strip body 821 is provided with a first pending connection section 822 and a second pending connection section 823 on its left and right sides, respectively.

Wherein, the first pending connection section 822 mates with the first mating section 222. Once mated, the elastic strip body 821 forms an inclined plane. The upper surface of the elastic strip body 821 at the end of the second pending connection section 823 is higher than upper surface of the elastic strip body 821 at the end of the first pending connection section 822, or the lower surface of the elastic strip body 821 at the end of the second pending connection section 823 is higher than the lower surface of the elastic strip body 821 at the end of the first pending connection section 822.

The pickup truck tailgate rear cover is further provided with a fixing plate Q7 located near the front of the vehicle, the width of the fixing plate is smaller than or equal to other plates.

The fixing plate Q7 is provided with a first supporting section 221 on the side and forms a first mating section 222 on the inner side of the first supporting section 221, the first mating section 222 mates with the first mating section 822 or the second mating section 823 of the elastic strip body 821.

A pickup truck tailgate cover in another embodiment, which is detachably mounted on the rear cargo hopper, comprising a plurality of panel assemblies spliced together.

Each panel assembly comprises a panel 1 and a plurality of frames 2 surrounding it.

The side of one panel assembly is connected to the side of an adjacent panel assembly by a adapter 8.

The side of the frame 2 is provided with a first supporting section 221 and forms a first mating section 222 on the inner side of the first supporting section 221.

The adapter 8 comprises an elastic strip 82, which comprises an elastic strip body 821 with an upper surface and a lower surface. The lower surface of the elastic strip body 821 is provided with a first pending connection section 822 and a second pending connection section 823 on its left and right sides, respectively.

Wherein, the first pending connection section 822 mates with the first mating section 222. The elastic strip 82 further comprises a supporting mating section 824, which is located at the bottom of the clastic strip body 821 or between the bottom of the elastic strip body 821 and the lower surface of the clastic strip body 821. The second pending connection section 823 mates with the frame of another panel, the first mating section 222 or the second mating section (812) on the rotating shaft 81.

The pickup truck tailgate rear cover is further provided with a fixing plate Q7 located near the front of the vehicle, the width of the fixing plate is smaller than or equal to other plates. It should be noted that the fixing plate Q7, can be connected to the guide rail or the car body by means of a locking part.

The side of the fixing plate Q7 is provided with a first supporting section 221 (not shown in FIG. 13, see other accompanying drawings, e.g., shown in FIG. 9), and forms a first mating section 222 on the inner side of the first supporting section 221, the first mating section 222 mates with the first mating section 822 or the second mating section 823 of the elastic strip body 821. The fixing plate is connected to the rotating shaft 81 or to the frame of the plate body 1 by the elastic body. The elastic strip 82 is without or with a supporting mating section.

In the description of this specification, specific features, structures, materials, or characteristics may be combined in any one or more embodiments or examples in a suitable manner.

The invention is not limited to the above-mentioned optional embodiments. Anyone can come up with various other forms of products under the inspiration of the invention, however, regardless of any changes in its shape or structure. All technical solutions that fall within the scope defined by the claims of the present invention shall fall within the scope of protection of the invention.

1. A pickup truck tailgate rear cover, detachably mounted on the rear cargo hopper, comprising a plurality of panel assemblies spliced together, characterized in that:
Each panel assembly comprises a panel (1) and a plurality of frames (2) surrounding it.
The side of one panel assembly is connected to the side of an adjacent panel assembly by an adapter (8).
The side of the frame (2) is provided with a first supporting section (221), with a first mating section (222) formed on the inner side of the first supporting section (221).
The adapter (8) comprises an elastic strip (82), which comprises an elastic strip body (821) with an upper surface and a lower surface. The lower surface of the clastic strip body (821) is provided with a first pending connection section (822) and a second pending connection section (823) on its left and right sides, respectively.
The first pending connection section (822) mates with the first mating section (222). Once mated, the elastic strip body (821) forms an inclined plane. The upper surface of the clastic strip body (821) at the end of the second pending connection section (823) is higher than that at the end of the first pending connection section (822), or the lower surface of the elastic strip body (821) at the end of the second pending connection section (823) is higher than that at the end of the first pending connection section (822).

2. A pickup truck tailgate rear cover according to claim 1, characterized in that a plurality of guide rails (3) are arranged at the end surface of the panel assembly, the guide rails (3) are connected to the panel assembly through the locking parts (5), wherein one of the guide rails (3) is connected to an adjacent guide rail (3) through a connector (7).

3. A pickup truck tailgate cover according to claim 1, characterized in that the adapter (8) further comprises a rotating shaft (81), both the left and right sides of the rotating shaft (81) is provided with a second supporting section (811), the second mating section (812) is formed on the inner side of the second supporting section (811), the first pending connection section (822) or the second pending connection section (823) is connected to the second mating section (812).

4. A pickup truck tailgate rear cover, detachably mounted on the rear cargo hopper, comprising a plurality of panel assemblies spliced together, characterized in that:
Each panel assembly comprises a panel (1) and a plurality of frames (2) surrounding it.
The side of one panel assembly is connected to the side of an adjacent panel assembly by a adapter (8).
The side of the frame (2) is provided with a first supporting section (221), with a first mating section (222) formed on the inner side of the first supporting section (221).
The adapter (8) comprises an elastic strip (82), which comprises an elastic strip body (821) with an upper surface and a lower surface. The lower surface of the elastic strip body (821) is provided with a first pending connection section (822) and a second pending connection section (823) on its left and right sides, respectively.
Wherein, the first pending connection section (822) mates with the first mating section (222).
The elastic strip (82) further comprises a supporting mating section (824), which is located at the bottom of the elastic strip body (821) or between the bottom of the elastic strip body (821) and the lower surface of the elastic strip body (821). The second pending connection section (823) mates with the first mating section (222) in the frame of another panel or the second mating section (812) on the rotating shaft (81).

5. A pickup truck tailgate rear cover according to claim 1 or 4, characterized in that the elastic strip (82) further comprises a supporting mating section (824), which is provided at the bottom of the elastic strip body (821) or between the bottom of the clastic strip body (821) and its lower surface.

6. A pickup truck tailgate rear cover according to claim 5, characterized in that:
The left side of the supporting mating section (824) abuts the frame (2) of the panel, the right side of the supporting mating section (824) abuts the rotating shaft (81) or the frame (2) of another panel assembly.
The left side abutting part of the supporting mating section (824) is divided into its left upper surface and left lower surface, where the surface facing the elastic strip body (821) is defined as the upper surface.
The right side abutting part of the supporting mating section (824) is divided into its right upper surface and right lower surface, where the surface facing the elastic strip body (821) is defined as the upper surface.

7. A pickup truck tailgate rear cover according to claim 5, characterized in that the distance between the left abutting surface and the right abutting surface of the supporting mating section (824) is greater than or equal to the distance between section A and section B;
Wherein, section A refers to the section between the lower surface of the elastic strip body (821) at the frame (2) or rotating shaft (81) and the upper surface of the left abutting part of the supporting mating section (824) (including the upper surface contact point); section B refers to the section between the lower surface of the elastic strip body (821) at the frame (2) or rotating shaft (81) and the upper surface of the right abutting part of the supporting mating section (824) (including the upper surface contact point).

8. A pickup truck tailgate rear cover according to claim 5, characterized in that the supporting mating section (824) is in contact with the first supporting section (221) and/or the second supporting section (811).

9. A pickup truck tailgate rear cover according to claim 5, characterized in that the supporting mating section (824) may not make contact with the first supporting section (221) and/or the second supporting section (811).

10. A pickup truck tailgate rear cover according to claim 1 or 4, characterized in that:
A first sliding groove (211) is provided along the length direction of the frame (2);
A elongated hole (36) is provided on the surface perpendicular to the guide rail (3) and the extension surface of the guide rail (3);
The locking part (5) comprises a screw (55), the screw (55) passes through the elongated hole (36) to connect with the guide rail (3).

11. A pickup truck tailgate rear cover according to claim 10, characterized in that the locking part (5) further comprises a screw base (51) inserted into the first sliding groove (211). The screw (55) passes through the elongated hole (36) and is threadably connected to a nut (56), locking the guide rail (3) and the frame together.

12. A pickup truck tailgate rear cover according to claim 11, characterized in that a groove (52) is provided along the surface of the screw base (51) and comprises an opening (53). A rotating rod (54) is rotatably connected within the groove (52), the screw (55) is vertically connected to the center of the rotating rod (54). The screw (55) can swing along the opening (53).

13. A pickup truck tailgate rear cover according to claim 11, characterized in that a nut (56) abuts the guide rail body (31) and forms a mating surface (34) on the guide rail body (31), while a contact surface is formed at the nut (56).

14. A pickup truck tailgate rear cover according to claim 2, characterized in that:
The guide rail (3) is provided with a supporting block (4) at specific positions, the supporting block (4) is provided with a load-bearing section (42) to enhance the local rigidity of the guide rail (3).

15. A pickup truck tailgate rear cover according to claim 14, characterized in that:
A guide rail (3) comprises a guide rail body (31), the guide rail body (31) is provided with a second sliding groove (32) along the vertical direction, a supporting groove (33) is provided in the horizontal direction of the guide rail body (31);
A supporting block (4) is slidably connected within the guide rail (3), the supporting block (4) comprises a guide section (41) and a load-bearing section (42), which are vertically arranged;
The guide section (41) is slidably connected to the second sliding groove (32), while the load-bearing section (42) is slidably connected to the support groove (33).

16. A pickup truck tailgate rear cover according to claim 2, wherein:
The connector (7) comprises a connector female end (71) and a connector male end (72);
One part of the connector female end (71) is inserted into the second sliding groove (32) of one of the guide rails (3), while another part of the connector female end (71) is inserted into the second sliding groove (32) of an adjacent guide rail (3). An extension section (35) is provided on the inner side of the second sliding groove (32);
The connector male end (72) is provided opposite the connector female end (71), with at least two screw holes are provided corresponding to the surfaces of both the connector male end (72) and the connector female end (71). The connector male end (72) and the connector female end (71) are fixed together with screws and abut the extension section (35), connecting the adjacent guide rails (3) in series.

17. A pickup truck tailgate cover, detachably mounted on the rear cargo hopper, comprising a plurality of panel assemblies spliced together, characterized in that:
Each panel assembly comprises a panel (1) and a plurality of frames (2) surrounding it.
The side of one panel assembly is connected to the side of an adjacent panel assembly by a adapter (8).
The side of the frame (2) is provided with a first supporting section (221) and forms a first mating section (222) on the inner side of the first supporting section (221).
The adapter (8) comprises an elastic strip (82), which comprises an elastic strip body (821) with an upper surface and a lower surface. The lower surface of the elastic strip body (821) is provided with a first pending connection section (822) and a second pending connection section (823) on its left and right sides, respectively.
The first pending connection section (822) mates with the first mating section (222). Once mated, the elastic strip body (821) forms an inclined plane. The upper surface of the elastic strip body (821) at the end of the second pending connection section (823) is higher than that at the end of the first pending connection section (822), or the lower surface of the elastic strip body (821) at the end of the second pending connection section (823) is higher than that at the end of the first pending connection section (822).
The pickup truck tailgate rear cover is further provided with a fixing plate (Q7) located near the front of the vehicle, the width of the fixing plate is smaller than or equal to other plates; the fixing plate (Q7) is provided with a first supporting section (221) on the side and forms a first mating section (222) on the inner side of the first supporting section (221), the first mating section (222) mates with the first mating section (822) or the second mating section (823) of the clastic strip body (821).

18. A pickup truck tailgate cover, detachably mounted on the rear cargo hopper, comprising a plurality of panel assemblies spliced together, characterized in that:
Each panel assembly comprises a panel (1) and a plurality of frames (2) surrounding it.
The side of one panel assembly is connected to the side of an adjacent panel assembly by a adapter (8).
The side of the frame (2) is provided with a first supporting section (221) and forms a first mating section (222) on the inner side of the first supporting section (221).
The adapter (8) comprises an elastic strip (82), which comprises an elastic strip body (821) with an upper surface and a lower surface. The lower surface of the elastic strip body (821) is provided with a first pending connection section (822) and a second pending connection section (823) on its left and right sides, respectively.
The first pending connection section (822) mates with the first mating section (222). The elastic strip (82) further comprises a supporting mating section (824), which is located at the bottom of the elastic strip body (821) or between the bottom of the elastic strip body (821) and the lower surface of the elastic strip body (821). The second pending connection section (823) mates with the frame of another panel, the first mating section (222), or the second mating section (812) on the rotating shaft (81).
The pickup truck tailgate rear cover is further provided with a fixing plate (Q7) located near the front of the vehicle, the width of the fixing plate is smaller than or equal to other plates; the side of the fixing plate (Q7) is provided with a first supporting section (221) and forms a first mating section (222) on the inner side of the first supporting section (221), the first mating section (222) mates with the first mating section (822) or the second mating section (823) of the elastic strip body (821).
